(19) United States
(12) Patent Application Publication
(10) Pub. No.: US 2011/0290171 A1
(43) Pub. Date: Dec. 1, 2011

(54) ASSEMBLY FOR ATTACHING A FLAG TO AN OBJECT

(76) Inventors: Christopher Allen Brick, Wilson, NC (US); Michael John Brick, Winterville, NC (US); Charles Brian Totten, Knightdale, NC (US)

(21) Appl. No.: 12/862,730

(22) Filed: Aug. 24, 2010

Related U.S. Application Data
(60) Provisional application No. 61/349,152, filed on May 27, 2010.

(51) Int. Cl. G09F 17/00

(52) U.S. Cl. 116/173

(57) ABSTRACT

The subject matter described herein includes assemblies for attaching flags to objects. One assembly includes a base for attaching to an end of a flag mast. The assembly further includes a base receiving member for attaching to an object and to the base. The base receiving member forms a slot for slidably receiving the base and for locking the base to the base receiving member.

### PRIORITY CLAIM

This application claims the benefit of U.S. Provisional Patent Application Ser. No. 61/349,152, filed May 27, 2010; the disclosure of which is incorporated herein by reference in its entirety.

### TECHNICAL FIELD

The subject matter described herein relates to flags and assemblies for attaching flags to objects.

### BACKGROUND

Flags, such as novelty flags, flags with geographic or national indicia, sports flags, or banners, are often displayed on buildings, in yards, and on motor vehicles, including cars, boats, recreational vehicles, etc. Conventionally, flags have and continue to be displayed on stationary flag mounts or poles. However, in many instances, it may be desirable for mounting assemblies for flags to be portable so that a flag can be displayed on a vehicle and in other locations, such as in the owner's yard.

Flag mounting assemblies for motor vehicles are becoming increasingly popular, especially among sports fans. One current motor vehicle flag mounting assembly fits between the vehicle window glass and the window frame. One problem with this design is that if the window glass is lowered while the vehicle is moving, the flag, mast, and attachment assembly may blow away.

Another problem with this design is that it is not easily detachable from the exterior of the vehicle, requiring the user to lower the window glass to remove the flag. Yet another problem with this type of flag mounting assembly is that it is not suitable for mounting flags in locations other than the motor vehicle window frames.

Another type of flag mount for motor vehicles attaches to the luggage rack. However, one existing design uses a bolt to attach the flag mast to the luggage rack, which requires tools for removal. Also, like flag mounting assemblies that attach to motor vehicle window frames, conventional luggage rack mounts are unsuitable for displaying flags in locations other than on a vehicle luggage rack.

Accordingly, in light of these difficulties, there exists a need for improved assemblies for attachment of flags to objects.

### SUMMARY

The subject matter described herein includes assemblies for attaching flags to objects. One assembly includes a base for attaching to an end of a flag mast. The assembly further includes a base receiving member for attaching to an object and to the base. The base receiving member forms a slot for slidably receiving and locking the base to the base receiving member.

### BRIEF DESCRIPTION OF THE DRAWINGS

Preferred embodiments of the subject matter described herein will now be explained with reference to the accompanying drawings of which:

FIG. 1 is a perspective view of assembly for attaching a flag to an object according to an embodiment of the subject matter described herein;

FIG. 2 is a perspective view illustrating a flag mast base and a base receiving member where the flag mast base is in the unlocked position according to an embodiment of the subject matter described herein;

FIG. 3 is a perspective view illustrating the sliding of the flag mast base into the flag mast base receiving member according to an embodiment of the subject matter described herein;

FIG. 4 is a perspective view illustrating the flag mast base and the base receiving member where the flag mast base is in a locked position according to an embodiment of the subject matter described herein;

FIG. 5 is a side view illustrating a flag base receiving member where object attachment members are in a closed position according to an embodiment of the subject matter described herein;

FIG. 6 is a side view of a flag mast base receiving member where the object attachment members are in an open position according to an embodiment of the subject matter described herein;

FIG. 7 is a perspective view of a flag base receiving member attached to an object, such as a motor vehicle luggage rack, according to an embodiment of the subject matter described herein;

FIG. 8 is a perspective view illustrating an assembly for attaching a flag to an object where the object comprises a land base according to an embodiment of the subject matter described herein;

FIG. 9 is a perspective view illustrating an assembly for attaching a flag to an object and an exemplary flag according to an embodiment of the subject matter described herein;

FIG. 10 is a perspective view of an assembly for attaching a flag to an object according to an alternate embodiment of the subject matter described herein;

FIG. 11 is a perspective view of an insert for attaching a flag to an object shown in the embodiment illustrated in FIG. 10;

FIG. 12 is a perspective view of an assembly for attaching a flag to an object according to yet another alternate embodiment of the subject matter described herein; and

FIG. 13 is perspective view of an insert for attaching a flag to an object shown in FIG. 12.

### DETAILED DESCRIPTION

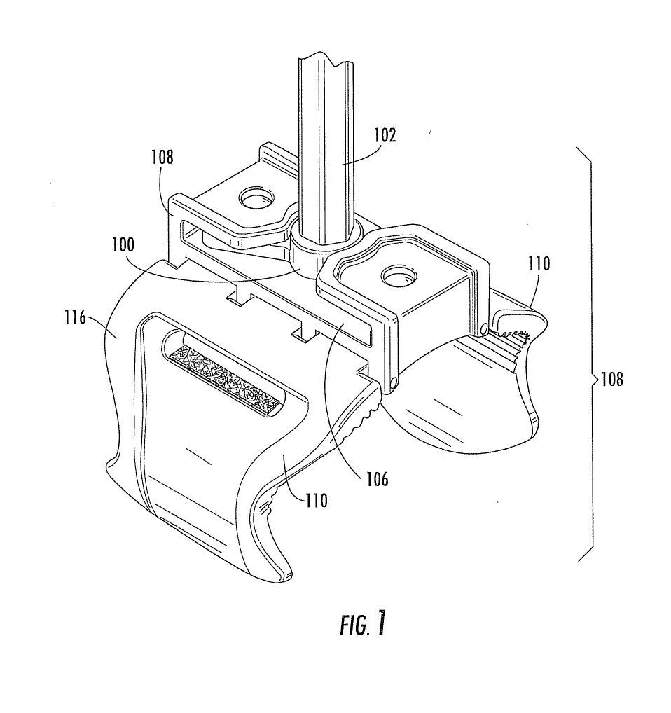

The subject matter described herein includes assemblies for attaching a flag to an object. FIG. 1 is a perspective view illustrating an exemplary assembly for attaching a flag to an object according to an embodiment of the subject matter described herein. Referring to FIG. 1, the assembly includes a flag mast base 100 that attaches to an end of a flag mast 102. A flag mast base receiving member 104 includes an upper portion 106 that forms a slot 108 for slidably receiving and locking base 100 to base receiving member 104. Base receiving member 104 also includes object attachment members 110 that are hingedly attached to upper portion 106 for attaching to an object. Each object attachment member 110 includes a slot 112 for receiving a strap (not shown in FIG. 1) for securing base receiving member 104 to the object.

Base 100 and base receiving member 104 illustrated in FIG. 1 may be made of any suitable material. The material for upper portion 106 of base receiving member 104 is preferably rigid to hold base 100 in position. Base 100 is preferably also rigid for the same reason and to support flag mast 102 and a flag. In one example, base 100 and base receiving member 104 may be formed of a fiber reinforced plastic material. Object attachment members 110 may be formed of the same material as upper portion 106. However, because object attachment members 110 may be required to fit around an object and flex, it may be desirable to make object attachment members 110 of a more flexible material, such as a rubber material or a rubberized plastic material.

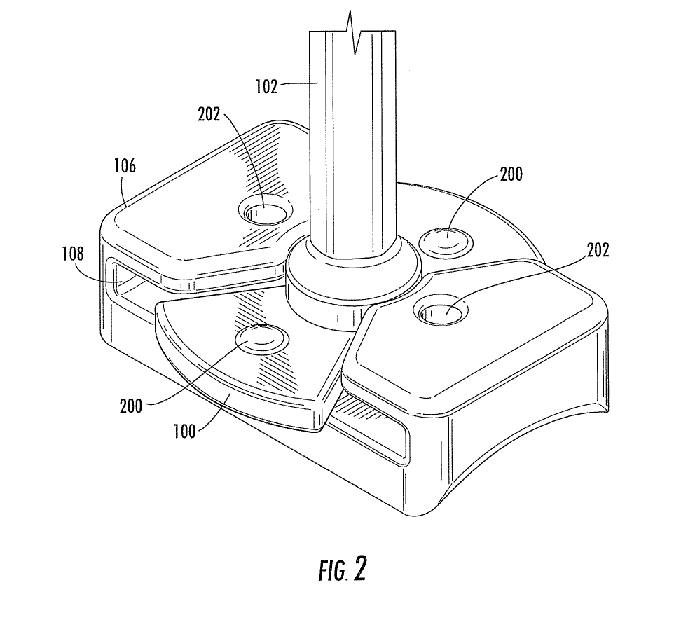

In one example, flag mast base 100 twists or rotates into base receiving member 104. FIG. 2 is a perspective view illustrating flag mast base 100 inserted into upper portion 106 of base receiving member 104 where flag mast base 100 is in an unlocked position. In FIG. 2, base 100 has a bowtie configuration with protrusions 200 located on opposing ends of the bowtie that fit into corresponding apertures 202 in upper portion 106 of base receiving member 104.

As will be described in more detail below, flag mast base 100 may be configured to couple flag mast to a plurality of different objects. For example, in the embodiment illustrated in FIG. 2, flag mast base 100 is slidably and detachably couplable to base receiving member 104, which is configured to attach to a motor vehicle luggage rack. Flag mast base 100 may also be couplable to other types of mounts, such as land mounts that are displayed in a user's yard. In such an embodiment, a user could display a flag on his motor vehicle when returning from a sporting event and thereafter remove the flag from his motor vehicle and display the same flag in the user's yard.

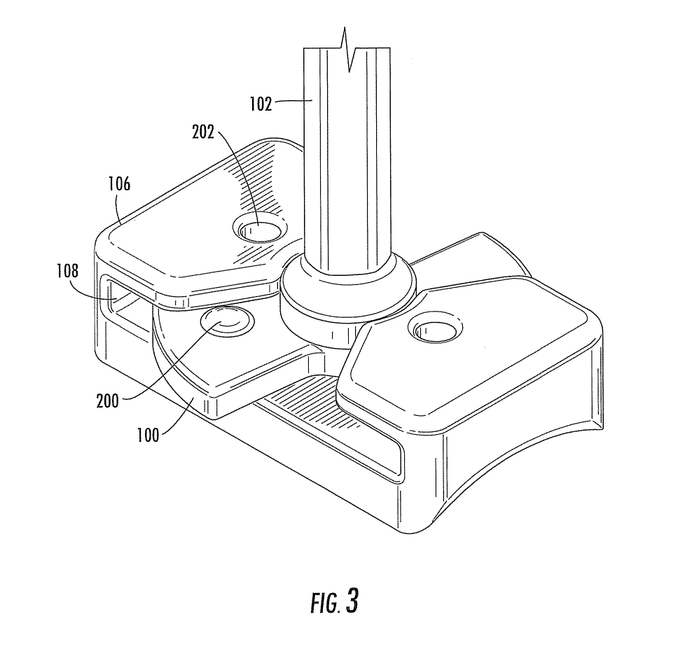

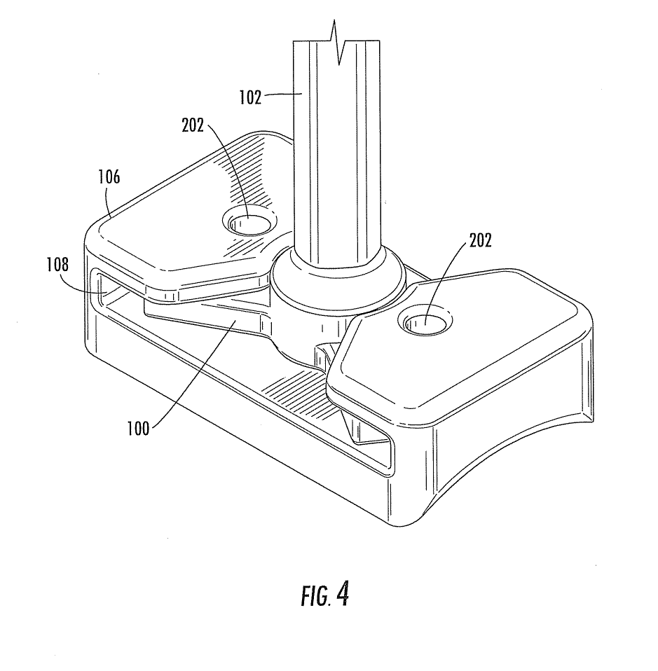

FIG. 3 is a perspective view illustrating the rotating of base receiving member 104 into slot 108 of upper portion 106 towards the locked position. FIG. 4 illustrates base 100 locked into upper portion 106 of base receiving member 104 such that protrusions 200 engage apertures 202.

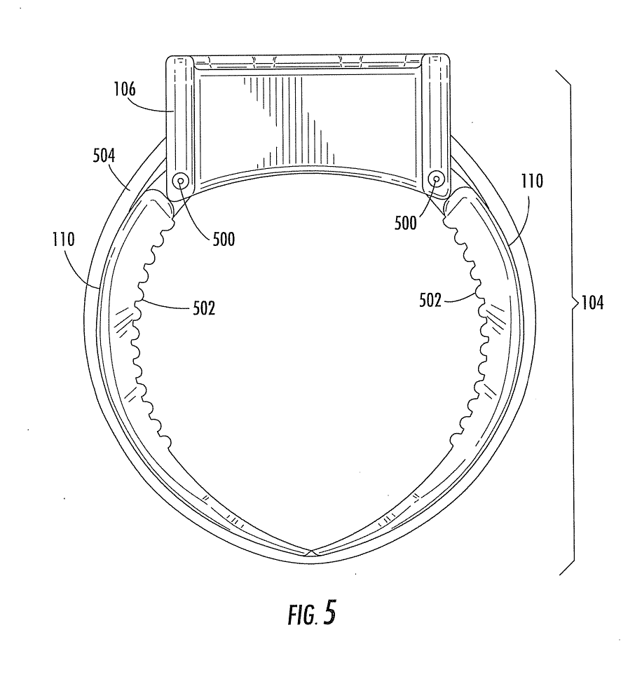

FIG. 5 is a side view illustrating object attachment members 110 of base receiving member 104 in more detail. Referring to FIG. 5, each object attachment member 110 is hingedly attached to upper portion 106 of base receiving member 104 via a hinge 500. Each object attachment member 110 also includes ribs 502 for facilitating frictional coupling to an object and prevent undesired rotation base receiving member 104.

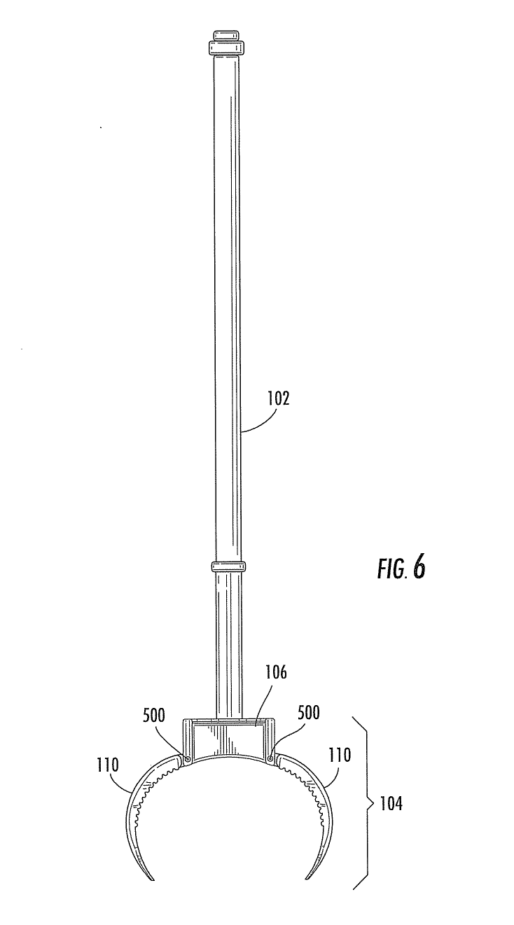

FIG. 6 is a side view illustrating base receiving member 104 with object attachment members 110 in the open position for attaching to an object. Each hinge 500 may include a spring that biases object attachment members 110 to the closed position for facilitating secure attachment to an object.

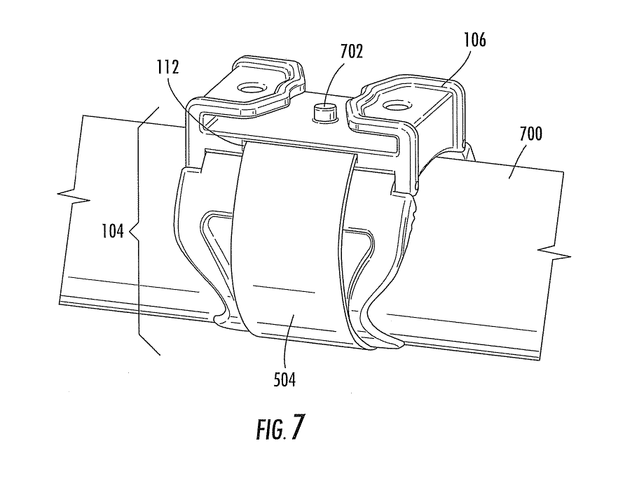

As stated above, base receiving member 104 may include a strap or other mechanism for locking base receiving member 104 to an object. FIG. 7 is a perspective view illustrating the securing of base receiving member 104 around an object. Referring to FIG. 7, base receiving member 104 attaches to an object 700, which may be a bar on a luggage rack of a motor vehicle. A strap 504 is inserted through slots 112 in base receiving member 104 to secure base receiving member 104 to object 700. Strap 504 may include any suitable latching mechanism, such as hook and loop fasteners, mating connectors on opposing ends, etc. The length of strap 504 that surrounds object 700 may be adjustable to support varying outer dimensions of object 700. Also illustrated in FIG. 7 is central protrusion 702 extending outward from upper portion 106 of base receiving member 104. Central protrusion 702 engages a depression in the underside of base 100 to center base 100 in base receiving member 104 and to facilitate the aforementioned slidable coupling and locking.

In the example illustrated in FIG. 7, object 700 may be a tubular cross member of a vehicle luggage rack. However, the subject matter described herein is not limited to mounting flags to motor vehicle luggage racks. In an alternate implementation, base receiving member 104 may be configured to mount to a motor vehicle spoiler, on a roll bar, on a T-top, on a bar of a motorcycle seat, etc.

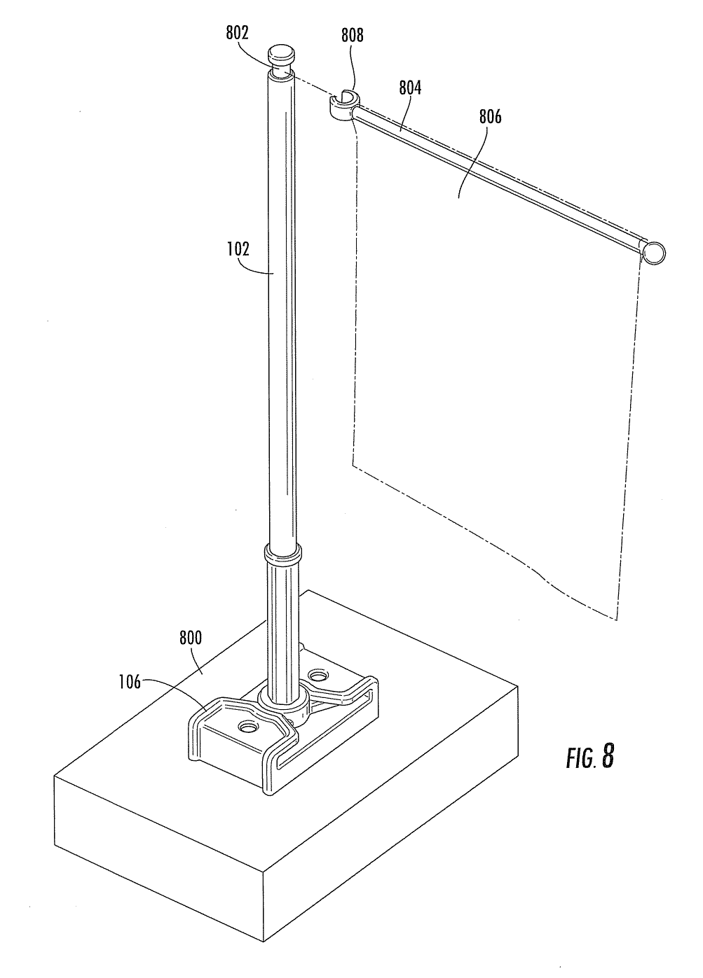

As stated above, base receiving member 104 may attach to any suitable object. In one example, base receiving member 104 or a portion thereof may attach to a land base. FIG. 8 illustrates upper portion 106 of base receiving member 104 attaching to a land base 800. Object attachment members 110 may be omitted if land base 800 includes upper portion 106 of base receiving member 104. Land base 800 may be any suitable structure for supporting flag mast 102 in a stable manner. In the illustrated example, land base 800 comprises a parallelepiped structure. However, any suitable shape for land base 800 is intended to be within the scope of the subject matter describer herein.

FIG. 8 also illustrates details of flag mast 102 according to an embodiment of the subject matter described herein. In FIG. 8, flag mast 102 includes a recess 802 for receiving a flag support arm 804. Flag support arm 804 includes a mast attachment member 806 that is open on one side and that has an inner diameter corresponding to that of recess 802 for snapping around recess 802. Flag support arm 804 may slide into a corresponding sleeve in flag 806 to support flag 806 in an unfurled position, regardless of wind conditions.

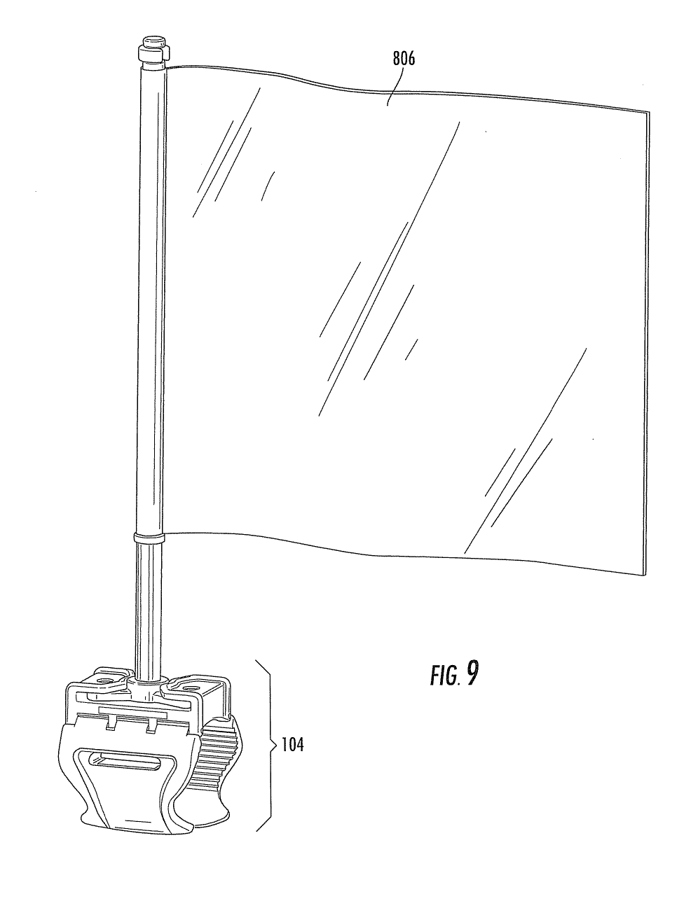

FIG. 9 is a perspective view illustrating an example of an assembly for supporting a flag and an exemplary flag 806. In FIG. 9, flag 806 is shown without sports or other indicia to be fully compliant with United States Patent and Trademark Office standards for black and white line drawings. Flag 806 could be any suitable type bearing any suitable emblem or other indicia. For example, flag 806 could be checkered flag of the type used to signal victory in an automobile race. In another example, flag 806 may include geographic or national designations, advertisements, sports logos, or any suitable indicia that a user desires to display.

In one embodiment of the subject matter described herein, base 100 may be fixedly attached to flag mast 102 and sold as an integral unit. Flags, such as flag 806, may be sold separately to allow users to change flags for different events. In another example, base 100 may be detachable couplable to mast 102 and sold separately along with flag base receiving member 104. In such an example, a user could buy a flag 806 with the corresponding flag mast 102 that fits into base 100. Either configuration is intended to be within the scope of the subject matter described herein.

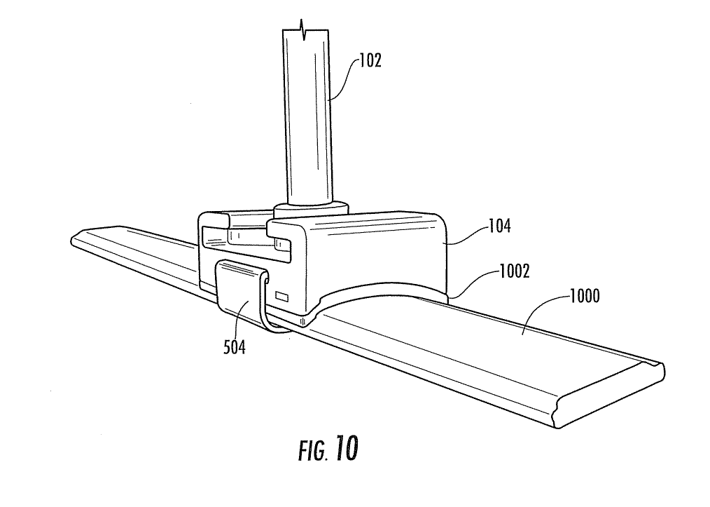

In the embodiment illustrated in FIG. 1, the assembly for attaching a flag to an object includes object attachment members 110 for attaching base receiving member 104 to an object. In an alternate embodiment, object attachment members 110 can be omitted. FIG. 10 illustrates an example of base receiving member 104 attached to an object where object attachment members 110 are omitted according to an embodiment of the subject matter described herein. Referring to FIG. 10, base receiving member 104 attaches to an oval shaped bar 1000 using strap 504 and without using object attachment members 110. The configuration illustrated in FIG. 10 works particularly well for attaching base receiving member 104 to oval shaped objects, such as a crossbar that extends across the luggage rack on a motor vehicle. In order to prevent base receiving member 104 from slipping, an insert 1002 may be positioned between base receiving member 104 and object 1000. Insert 1002 may be formed of a rubber material that compresses between base receiving member 104 and object 1000 when strap 504 is tightened. Insert 1002 may increase the friction between base receiving member 104 and object 1000 for reduced slipping. This increase in friction can be particularly important where object 1000 is mounted to a moving surface, such as the roof of a motor vehicle.

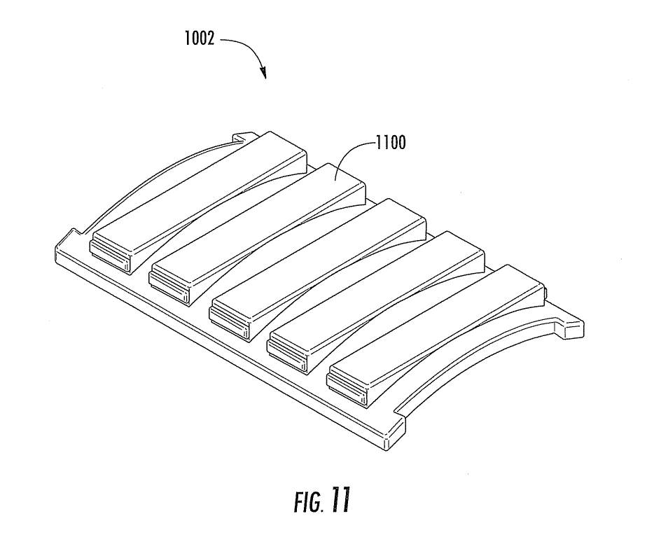

FIG. 11 is a perspective view of insert 1002. As can be seen in FIG. 11, insert 1002 includes protrusions or ribs 1100 that fit into corresponding slots on the underside of base receiving member 104.

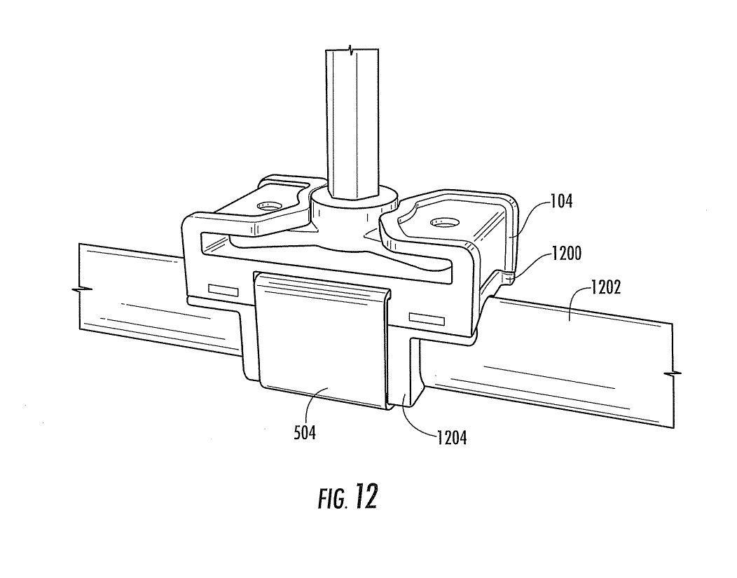

FIG. 12 is a perspective view of yet another embodiment of an assembly for attaching a flag to an object where a different insert 1200 is positioned between base receiving member 104 and object 1202. In the illustrated example, insert 1200 is designed for attaching base receiving member 104 to round objects having small radii, i.e., between about 1 inch and about 1¾ inches. In the illustrated example, like the previous example, insert 1200 is compressed between base receiving member 104 and object 1202 when strap 504 is tightened. Insert 1200 may be formed of any suitable compressive material that increases the friction between base receiving member and object 1202, such as a rubber material. It should be noted that when strap 504 is tightened, each arm 1204 tightens about radially opposing

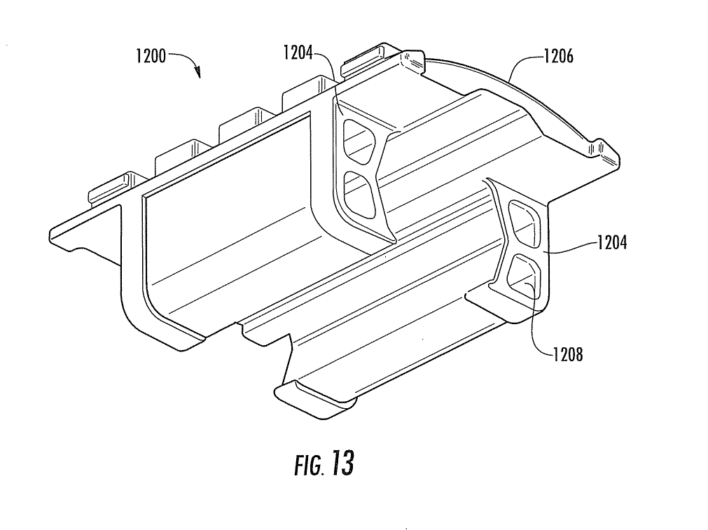

FIG. 13 is a perspective view of insert 1200. As shown in FIG. 13, insert 1200 includes arms 1204 that are positionable on radially opposite sides of an object to which insert 1200 is attached. Insert 1200 also includes a main body portion 1206 from which arms 1204 extend. Arms 1204 and main body 1206 form an enclosure that encloses a substantial portion around objects when insert 1200 is positioned around an object and strap 504 is tightened. Depending on the radius of the object, insert 1200 can enclose at least about 270° of the object. Each arm 1204 of insert 1200 also includes elongate passageways 1208 for enhancing the compressibility of arms 1204.

It will be understood that various details of the subject matter described herein may be changed without departing from the scope of the subject matter described herein. Furthermore, the foregoing description is for the purpose of illustration only, and not for the purpose of limitation.

What is claimed is:

1. An assembly for attaching a flag to an object, the assembly comprising:
a flag mast base for attaching to an end of a flag mast; and
a flag mast base receiving member for attaching to an object and to the flag mast base, wherein the flag mast base receiving member forms a slot for slidably receiving and locking the flag mast base to the flag mast base receiving member.

2. The assembly of claim 1 wherein the flag mast base is configured to twist into the slot.

3. The assembly of claim 2 wherein the flag mast base has a bowtie configuration.

4. The assembly of claim 3 wherein the flag mast base includes protrusions located on opposite ends of the bowtie that lock into corresponding apertures of the flag mast base receiving member.

5. The assembly of claim 1 wherein the flag mast base receiving member includes an upper portion that includes the slot and object attachment members hingedly attached to the upper member for attaching to the object.

6. The assembly of claim 5 wherein the object attachment members include an open position for receiving a portion of the object and a closed position for fitting around the object.

7. The assembly of 6 comprising means for securing the object attachment members around the object.

8. The assembly of claim 7 wherein the means for securing comprises a strap.

9. The assembly of claim 5 wherein the object attachment members are configured to attach to the luggage rack or other structure of a motor vehicle.

10. The assembly of claim 1 wherein the object comprises a land base.

11. The assembly of claim 1 comprising a flag support arm for supporting a flag in an unfurled position and for attaching the flag to the flag mast.

12. The assembly of claim 1 wherein the flag mast base receiving member includes a slot for receiving a strap for attaching the flag mast base receiving member to the object.

13. The assembly of claim 12 comprising an insert locatable between the flag mast base receiving member and the object.

14. The assembly of claim 13 wherein the insert is configured to prevent slipping of the flag mast base receiving member with respect to the object.

15. The assembly of claim 12 wherein the insert is configured to adapt the flag mast base receiving member to a radius of the object.

16. An assembly for attaching a flag to an object, the assembly comprising:
a flag mast for supporting a flag;
a flag mast base for attaching to an end of the flag mast; and
a flag mast base receiving member for attaching to an object and to the flag mast base, wherein the flag mast base receiving member forms a slot for slidably receiving and locking the flag mast base to the flag mast base receiving member.

17. The assembly of claim 16 wherein the flag mast base is configured to twist into the slot.

18. The assembly of claim 17 wherein the flag mast base has a bowtie configuration.

19. The assembly of claim 18 wherein the flag mast base includes protrusions located on opposite ends of the bowtie that lock into corresponding apertures of the flag mast base receiving member.

20. The assembly of claim 16 wherein the flag mast base receiving member includes an upper portion that includes the slot and object attachment members hingedly attached to the upper member for attaching to the object.

21. The assembly of claim 20 wherein the object attachment members include an open position for receiving a portion of the object and a closed position for fitting around the object.

22. The assembly of 21 comprising means for securing the object attachment members around the object.

23. The assembly of claim 22 wherein the means for securing comprises a strap.

24. The assembly of claim 20 wherein the object attachment members are configured to attach to the luggage rack or other structure of a motor vehicle.

25. The assembly of claim 16 wherein the object comprises land base.

26. The assembly of claim 16 comprising a flag support arm for supporting a flag in an unfurled position and for attaching the flag to the flag mast.

27. An assembly for attaching a flag to an object, the assembly comprising:
a flag mast for supporting a flag; and
a flag mast base for attaching to an end of the flag mast, the flag mast base having a bowtie configuration for slidable and detachable coupling to a plurality of different objects.
